(19) United States
(12) Patent Application Publication
(10) Pub. No.: US 2006/0005776 A1
(43) Pub. Date: Jan. 12, 2006

(54) Photo-luminescent poultry watering system

(76) Inventor: Lamar Williams, Danielsville, GA (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 10/886,849

(22) Filed: Jul. 8, 2004

(51) Int. Cl. A01K 39/02

(52) U.S. Cl. 119/72.5

(57) ABSTRACT

A poultry watering device for use with a conduit system in a confinement house having at least a portion thereof associated with the actuation of the device by birds marked by a photo-luminescent material such that the birds can drink therefrom in darkness or low light conditions.

### BACKGROUND OF THE INVENTION

The present invention relates to the field of livestock husbandry and more particularly to the field of poultry production. In greater particularity, the present invention relates to the field poultry production with respect to the housing and environmental aspects of raising poultry to a marketable size and weight. In even greater particularity, the present invention relates to providing poultry with adequate periods of dark and light and sufficient water during such periods to optimize growth in the birds and to minimize hydration stress.

Poultry science has progressed in the management of temperature, water, and light such that these and other parameters are increasingly viewed as efficiency variables in the same manner as nutrition. One factor which has been recently received attention relates to the effect of light and darkness on the growth rate of poultry. There is a possibility that by managing light and darkness, the fowl can be allowed to feed and rest in periods which will increase the rate of growth. This may be related to the tendency of fowl to roost in darkness, thereby reducing their metabolic requirements as compared to the normal activities during the waking hours. Accordingly, some experimentation has been undertaken to determine the efficiency of the growth cycle by artificially darkening the confinement house to allow the poultry to rest. Although some results indicate that there is an increase in growth due to lower light conditions, and adverse aspect may be that poultry tend to roost and do not move to drink during periods of darkness, thus some birds may have hydration stress induced by increased period of darkness due to the roosting phenomenon.

### SUMMARY OF THE PRESENT INVENTION

It is an object of the present invention to provide an improved watering system to poultry confinement houses.

Another object of the invention is to induce poultry to drink water during periods of darkness.

Yet another object of the invention is to reduce hydration stress in poultry while reducing the amount of light received in poultry houses.

Still another object of the invention is to increase the weight gain of poultry per unit of time by reducing energy consumption and increasing water consumption.

These and other objects and advantages of the invention are accomplished by a modification to existing watering systems to make them visible to poultry in low light or darkness conditions. More particularly, the present invention utilizes photo-luminescent materials in the vicinity of the water outlets to allow the poultry to locate the water outlets in the dark. The various structural variations and the manner in which the objects of the invention are accomplished will become apparent from the following detailed description of the preferred embodiment of the invention.

### BRIEF DESCRIPTION OF THE DRAWINGS

An apparatus embodying the features of the present invention is depicted in the accompanying drawings which form a portion of this disclosure and wherein:

FIG. 1 is a perspective view of a modern watering system in a poultry confinement house;

FIG. 2 is a side elevation view of a nipple type watering device showing activation of the device by poultry;

FIG. 3 is a sectional view of a typical watering device with various components which can be used as a photo-luminescent marker in accordance with the present invention.

FIG. 4 is side elevation view of a nipple type watering device with a portion of the housing made from photo-luminescent marker.

FIG. 5 is a side elevation view of a watering device with a lower photo luminescent marker.

FIG. 6 is a side elevation view of a watering device with clip on photo luminescent marker.

### DESCRIPTION OF THE PREFERRED EMBODIMENT

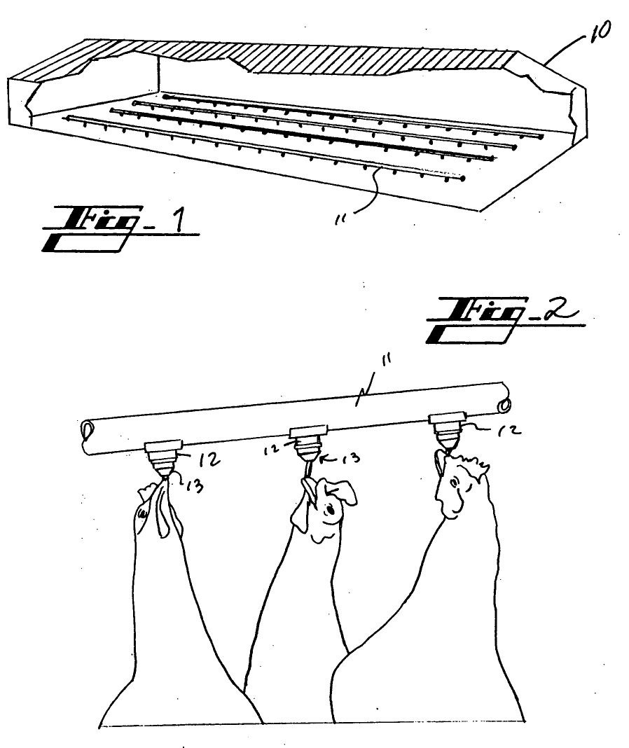

Referring to FIGS. 1 to 6, it will be appreciated that the invention is intended for use in commercial poultry houses 10 in which a watering system provides water to thousands of birds. Typically the house 10 has an external source of water, not shown and a network of conduits 11 supplying water under low pressure throughout the house 10. The conduits 11 will have a number of drop pipes 12 or extensions which terminate in valved drinking units 13. Such units are shown in U.S. Pat. Nos. 4,185,590; 4,770,126; 5,293,836; and others. As noted in various instances in the cited patents poultry quickly learn to drink from these valved drinking units by actuating the valve with their beak. However, even though there are thousands of such drinking units in a confinement house, the majority of the poultry confined therein do not drink in darkness.

The present invention provides the drinking unit with a photo-luminescent marker which is visible to the poultry in low light or dark conditions. Observation in confinement houses in which prototypes of the markers were installed show that poultry generally settled down to roost when the lights go out, but also rise to drink from the marked drinking units even in darkness, then return to the roosting position.

Accordingly, as shown in FIGS. 2 to 6 the drinking units 13 typically include body unit 40, valve actuating member 50, metering pin 70 and an internal valve chamber 80. Drinking units 13 are attached to conduit system 11 as described in the prior art. It known to make housing 40 out of ABS plastic. Housing 40 has a frusto-conical bore 44 located at one end, which provides the outlet for water as is well known. Actuating member 50 includes a generally cylindrical pin 52 with an actuator head, not shown, disposed at one end thereof within the housing 40. As described in U.S. Pat. No. 5,293,836 a drinking disc 60 may be disposed on actuating member 52 in a nipple type drinker as shown in FIG. 2 and may be made from plastic, metal or any suitable material.

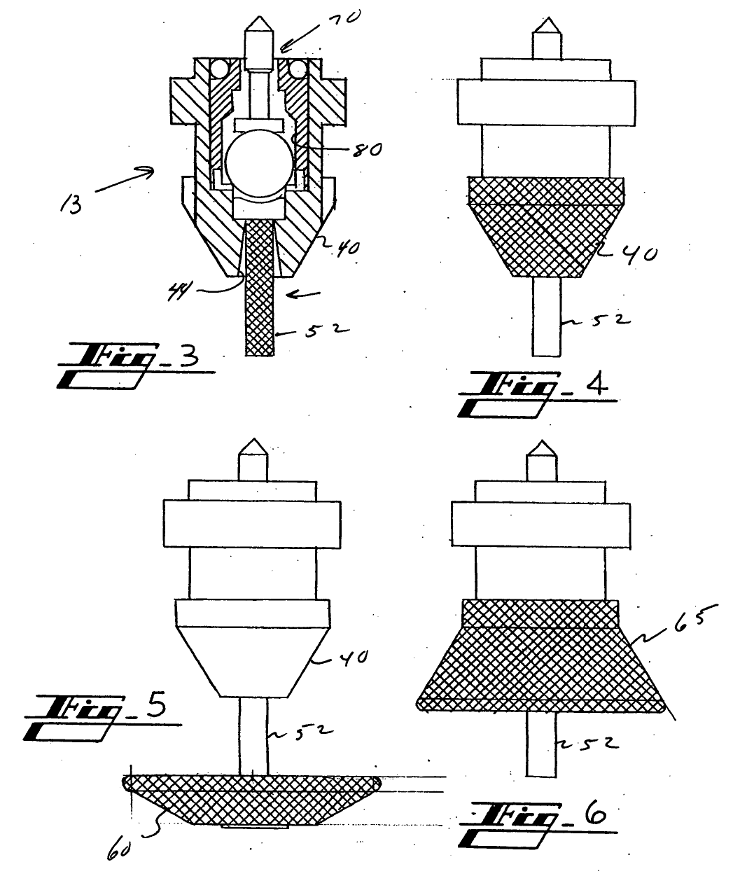

Photo-luminescent pigments are available which are non toxic, water proof, non-radioactive and which can be blended with plastics or ceramics, mixed in paint, and applied to films or tapes. These pigments are activated by exposure to light from incandescent bulbs, fluorescent lighting, sunlight or UV light depending on the type pigment selected and will remain luminescent for up to several hours in darkness. Accordingly in FIG. 4, the plastic body or housing 40 is made with photo-luminescent pigments in the plastic such that the housing 40 glows in the dark. Alternatively, for disk watering stations, the disk 60 may be made completely or partially from plastic or ceramic which is impregnated with photo-luminescent pigment such that the poultry can see the disc directly as in FIG. 5. In drinking units without discs, trigger pin 52 may be painted with luminescent paint which is waterproof and durable as in FIG. 3. Likewise all or part of a metal watering disc 60 may be painted with photo-luminescent paint. Although photo-luminescent tape is available and is considered within the scope of the claims for use in each instance in which the component is made from or painted with photo-luminescent material, the durability of such tape in this application has not been evaluated. Also encompassed within the scope of the invention is a retrofit adapter 65 made from photo-luminescent material that can be attached to the drinking unit such as depicted in FIG. 6. The physical construction of such units will be dependant upon the type watering units are in place. Flexible tabs may be provided to support a marker, or the marker may comprise a sleeve or snap on rim made from plastic or other suitable photo-luminescent material.

Other type drinkers which are amenable to use with the present invention. As with FIG. 3-5, selected components may be made from photo-luminescent material or may be painted or coated with such material in a manner that will allow the poultry to see the drinker mechanism in the dark and allow the poultry to actuate the drinker and return to roosting.

It is to be understood that the form of the invention shown is a preferred embodiment thereof and that various changes and modifications may be made therein without departing from the spirit of the invention or scope as defined in the following claims.

What is claimed is:

1. In a poultry confinement house having a plurality of poultry watering stations the improvement comprising, a photo-luminescent marker indicating at least one watering station in a low light condition.

2. The improvement as defined in claim 1 wherein said photo-luminescent marker is associated with a nipple type watering device.

3. The improvement as defined in claim 2 wherein said photo-luminescent marker comprises a photo-luminescent plastic element affixed to said nipple type watering device.

4. The improvement as defined in claim 2 wherein said photo luminescent marker is a layer of photo luminescent paint adhered to said nipple type watering device.

5. The improvement as defined in claim 2 wherein said photo luminescent marker comprises a photo-luminescent pigment incorporated into the body of said nipple type watering device.

6. The improvement as defined in claim 2 wherein said photo-luminescent marker comprises a photo luminescent material adhered to said nipple type watering device.

7. The improvement as defined in claim 2 wherein said photoluminescent marker comprises a ceramic component affixed to said nipple type watering device.

8. The improvement as defined in claim 1 wherein said photo-luminescent marker comprises a photo-luminescent plastic element affixed to said watering station.

9. The improvement as defined in claim 1 wherein said photo luminescent marker is a layer of photo luminescent paint applied to at least a part of said watering station.

10. The improvement as defined in claim 1 wherein said photo luminescent marker comprises a photo-luminescent pigment incorporated into the body of said watering station.

11. The improvement as defined in claim 1 wherein said photo-luminescent marker comprises a photo luminescent material adhered to said watering station.

12. The improvement as defined in claim 2 wherein said photo-luminescent marker comprises a ceramic insert affixed to said watering station.

13. The improvement as defined in claim 1 wherein said photo-luminescent marker may be selected from the group of plastic, ceramic, glass, tape or paint, each containing photo-luminescent pigments.

14. The improvement as defined in claim 14 wherein said photo luminescent pigments may be activated by incandescent light, sunlight, ultraviolet light, or florescent light.
